(19) United States
(12) Patent Application Publication
(10) Pub. No.: US 2021/0379939 A1
(43) Pub. Date: Dec. 9, 2021

(54) SELF-HEALING TIRE

(71) Applicant: Ghing-Hsin Dien, Taipei City (TW)

(72) Inventor: Ghing-Hsin Dien, Taipei City (TW)

(21) Appl. No.: 17/407,775

(22) Filed: Aug. 20, 2021

Related U.S. Application Data
(63) Continuation-in-part of application No. 16/032,525, filed on Jul. 11, 2018.

(30) Foreign Application Priority Data
Jul. 17, 2017 (TW) 106123816

(51) Int. Cl. B60C 19/12; B60C 5/02; B60C 29/04

(52) U.S. Cl. CPC B60C 19/12; B60B 21/02; B60C 29/04; B60C 5/02

(57) ABSTRACT

A self-healing pneumatic tire, which uses the sealant stored in the tire to fix a leak, is disclosed.

### CROSS REFERENCE TO RELATED APPLICATIONS

This application is a Continuation-In-Part (CIP) of an earlier filed, pending, application, having application Ser. No. 16/032,525 and filed on Jul. 11, 2018, which claims priority under 35 U.S.C. § 119(a) on Patent Application No(s). 106123816 filed in Taiwan, Republic of China on Jul. 17, 2017, the entire contents of which are hereby incorporated by reference.

### BACKGROUND

### Technology Field

The present disclosure relates to a tire having a self-healing function and, in particular, to a pneumatic tire that can seal a hole with the sealant stored in the tire.

### Description of Related Art

In the conventional self-healing tires, a layer of viscous sealant is usually coated on the inner layer of the pneumatic tire, or a closed sealant layer is provided on the inner surface of the tire tread. When the tire is punctured and leaving a hole passing through the sealant layer, the sealant will flow through the hole and fill the hole to prevent the tire from leaking. The disadvantage of these types of self-healing tires is that after the sealant seals the hole, the sealant cannot be refilled. In addition, the excess sealant cannot be recycled and reused, and most of these self-healing tires must be made in the tire factory, so the manufacturing cost is high and it is hard to repair.

Therefore, it is desired to provide a self-healing tire that can be manufactured with a lower cost. It is also desired not to manufacture the self-healing tire with any special process in the tire factory. Moreover, the self-healing tire can be acquired by retrofitting a conventional pneumatic tire. The self-healing tire is designed to stop a leak at the tire casing automatically and to prevent itself from becoming a flat tire. If the self-healing tire is punctured, the punctured hole can be repaired with the existing off-line tire repairing technique, and the amount of sealant required is kept at the minimum and the sealant can be recycled and/or refilled. Moreover, the self-healing tire with lesser weight is easier to steer and runs more stably and more efficiently. Accordingly, the manufacturing cost of the self-healing tire of this disclosure is significantly reduced, and the installation and repair of the self-healing tire can be much easier. These advantages of this disclosure will make the self-healing tire become more available and popular.

### SUMMARY

In view of the foregoing, an objective of this disclosure is to provide a self-healing tire that can be easily retrofitted from a pneumatic tire and can be repaired, thereby reducing the manufacturing and maintenance costs of the self-healing tire.

In one embodiment, a self-healing tire of this disclosure comprises a rim, a tire casing, an inner tube, at least one valve stem, a tire casing channel, an inner tube channel, a sealant storing layer and a partition structure. The rim has at least one nozzle hole. The tire casing is installed around the rim. The inner tube is disposed between the rim and the tire casing. The at least one valve stem protrudes from the at least one nozzle hole on the rim. The tire casing channel is disposed inside the at least one valve stem and is connected to a space between the tire casing and the inner tube. The inner tube channel is disposed inside the at least one valve stem and is connected to an internal space of the inner tube for inflating the inner tube. The sealant storing layer is disposed between the tire casing and the inner tube. The sealant storing layer stores a sealant which is injected through the tire casing channel. The partition structure is disposed between the tire casing and the inner tube. The partition structure separates the tire casing and the inner tube to form a space to accommodate the sealant so as to form the sealant storing layer. The tire casing is supported by the inflated inner tube. The high pressure air in the inflated inner tube pushes the inner tube surface and the partition layer against the inner side of the tire casing, so the tire casing can withstand the weight of the vehicle. The at least one valve stem further comprises at least one valve which is configured to control at least one of the tire casing channel and the inner tube channel.

In one embodiment, the partition structure is integrated with the inner tube and disposed on an outer surface of the inner tube.

In one embodiment, the partition structure is integrated with the tire casing and disposed on an inner surface of the tire casing.

In one embodiment, the at least one valve is a common valve. The valve stem further comprises a channel selection switch. The channel selection switch is configured to selectively control the common valve to be connected with the inner tube channel or the tire casing channel.

In one embodiment, the at least one valve includes a first valve and a second valve. The first valve is configured to control the tire casing channel. The second valve is configured to control the inner tube channel.

In one embodiment, the at least one nozzle hole includes only one nozzle hole. The at least one valve stem includes only one valve stem.

In one embodiment, the at least one nozzle hole includes a first nozzle hole and a second nozzle hole. The at least one valve stem includes a first valve stem and a second valve stem. The first valve stem protrudes from the first nozzle hole. The second valve stem protrudes from the second nozzle hole. The tire casing channel is disposed inside the first valve stem and is connected to the space between the tire casing and the inner tube. The inner tube channel is disposed inside the second valve stem and is connected to the internal space of the inner tube for inflating the inner tube. The first valve stem further comprises a tire casing valve which connects with the tire casing channel. The tire casing valve controls the tire casing channel. The second valve stem further comprises an inner tube valve which connects with the inner tube channel. The inner tube valve controls the inner tube channel.

In one embodiment, the sealant is a liquid sealant.

In one embodiment, a liquid pressure of the liquid sealant in the sealant storing layer is equal to an air pressure in the inner tube after the inner tube is inflated.

In one embodiment, when the tire casing is punctured, the liquid sealant flows to a punctured hole due to a lower air pressure caused by the punctured-hole-leakage, the outflow liquid sealant contacts the air and seals the punctured hole.

As mentioned above, this disclosure is to dispose an inner tube inside a pneumatic tire, which is originally configured without any inner tube, and to inject the sealant into the space between the tire casing and the inner tube, thereby forming a self-healing tire. The self-healing tire of this disclosure has a lower installation cost and can be easily repaired. In addition, the self-healing tire can be acquired by retrofitting an existing conventional pneumatic tire. If the self-healing tire is punctured, the tire casing or the inner tube can be uninstalled and repaired off-line with the existing repairing technique. Besides, the sealant inside the tire can be refilled or recycled through the nozzle(s). And with the partition structure to define the space for the sealant layer, the sealant can be stored at the desired places inside the tire where a punctured hole is most likely to occur, and so the amount of liquid sealant can be kept at the minimum requirement. The less amount of sealant required means the weight of the self-healing tire can be kept at a minimum, which is very important for the ease of steering and for the efficiency of the tire. Also, when the wheel is running, the partition structure can keep the liquid sealant in place and not to fluctuate in the tire. Moreover, the shape of the tire casing is directly held by the inflated inner tube and the partition structure. It is most likely that the stored sealant in the tire could be completely leaked out and lost when the tire casing is once punctured, especially when the wheel is running, due to the weight of the car, the inner tube is constantly and repeatedly pressing/depressing the sealant layer against the tire casing during tire rotation, and so the liquid sealant will be pressed out or pumped out through the leaking hole. But, with the self-healing tire of this disclosure, even when the tire casing is punctured and all the sealant stored in the tire is completely leaked out, the tire would not become a flat tire because the tire casing is directly supported by the inner tube, not by the sealant. The tire casing can keep in shape and withstand the weight of the car even when all the sealant is leaked out and lost. Accordingly, compared with other self-healing tires, the manufacturing cost of the self-healing tire of this disclosure can be significantly-reduced, the repair of the self-healing tire can be much easier, and the self-healing tire of this disclosure can be acquired by retrofitting an existing conventional tire. In addition, due to the partition structure, the self-healing tire of this disclosure requires only the minimum amount of sealant to work, it is easier to steer and has higher efficiency due to the lesser amount and weight of sealant required. And the tire rotates more stably as the sealant is kept in place by the partition structure. And the self-healing tire of this disclosure will not become a flat tire even when all the sealant in it is lost.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing a first embodiment of this disclosure;

FIG. 2 is a schematic diagram showing a second embodiment of this disclosure;

FIG. 3A is a schematic diagram showing a third embodiment of this disclosure;

FIG. 3B is a schematic diagram showing a fourth embodiment of this disclosure;

FIG. 4 is a schematic diagram showing a two-in-one valve stem of this disclosure; and

FIG. 5 is a schematic diagram showing another two-in-one valve stem of this disclosure.

FIG. 6 is a schematic diagram showing the partition structure being integrated with the outer surface of the inner tube.

FIG. 7 is a schematic diagram showing the partition structure being integrated with the inner surface of the tire casing.

### DETAILED DESCRIPTION OF THE DISCLOSURE

The present disclosure will be apparent from the following detailed description, which proceeds with reference to the accompanying drawings, wherein the same references relate to the same elements.

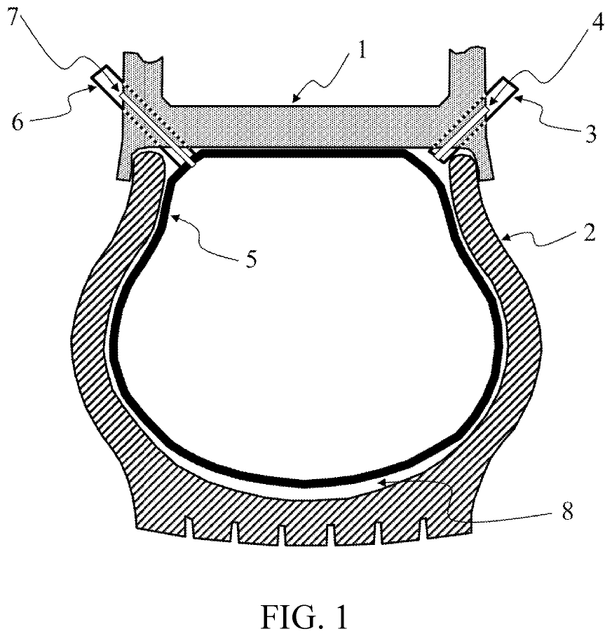

Referring to FIG. 1, a self-healing tire according to a first embodiment of this disclosure comprises a rim 1, a tire casing 2, a first valve stem (a first nozzle) 3, a tire casing channel 4, an inner tube 5, a second valve stem (a second nozzle) 6, an inner tube channel 7, and a sealant storing layer 8 disposed between the tire casing 2 and the inner tube 5. The rim 1 has a first nozzle hole and a second nozzle hole. The tire casing 2 is installed around the rim 1. The inner tube 5 is disposed between the rim 1 and the tire casing 2. The first valve stem 3 protrudes from the first nozzle hole, and second valve stem 6 protrudes from the second nozzle hole. The tire casing channel 4 is disposed inside the first valve stem 3 and connects to the space between the tire casing 2 and the inner tube 5. The inner tube channel 7 is disposed inside the second valve stem 6 and connects to the internal space of the inner tube 5. The first valve stem 3 (the first nozzle) further contains a tire casing valve (not shown) for controlling the tire casing channel 4, and the second valve stem 6 (the second nozzle) further contains an inner tube valve (not shown) for controlling the inner tube channel 7. The tire casing valve (not shown) is connected to the tire casing channel 4. The inner tube valve (not shown) is connected to the inner tube channel 7. The sealant storing layer 8 is configured for storing a sealant which is injected through the tire casing channel 4. After the inner tube 5 is inflated through the second valve stem 6 and the inner tube channel 7, the sealant can be injected to the sealant storing layer 8 between the tire casing 2 and the inner tube 5 through the first valve stem 3 and the tire casing channel 4. The sealant will be pressed by the air pressure of the inner tube 5 and uniformly distributed in the sealant storing layer 8 at the inner surface of the tire casing 2. The sealant can be a liquid sealant. The liquid pressure of the liquid sealant is equal to the air pressure inside the inner tube 5 after the inner tube 5 is inflated. If the tire casing 2 is punctured, the liquid sealant can be pressed by the inner tube 5 and flow through the punctured hole. Then, the outflow liquid sealant contacts the air and will seal the hole and prevent the leaking. If the tire casing 2 and the inner tube 5 are both punctured, the sealant will flow to the punctured holes due to the lower air pressure caused by the leakage. Accordingly, the liquid sealant can seal the punctured holes and stop the air leaking.

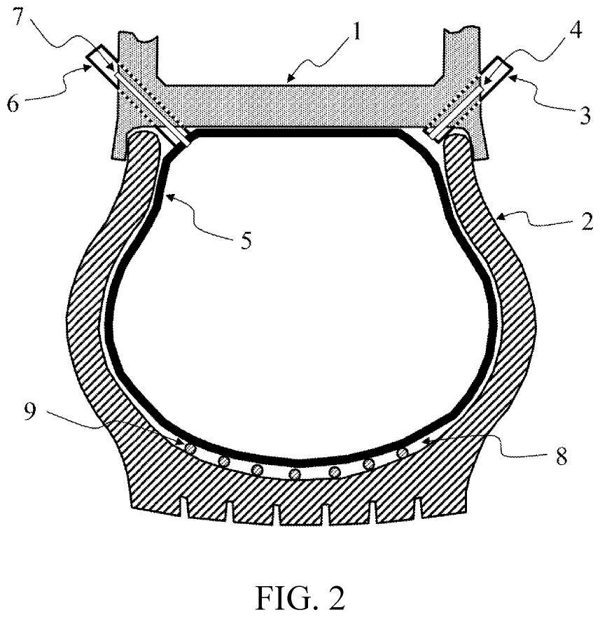

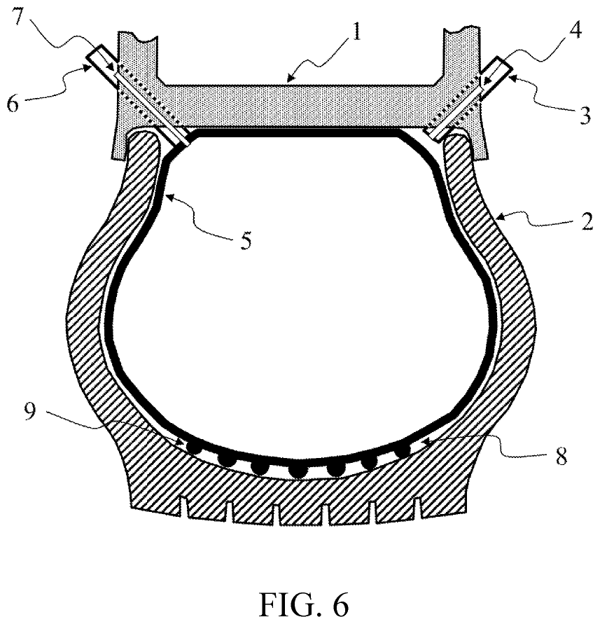

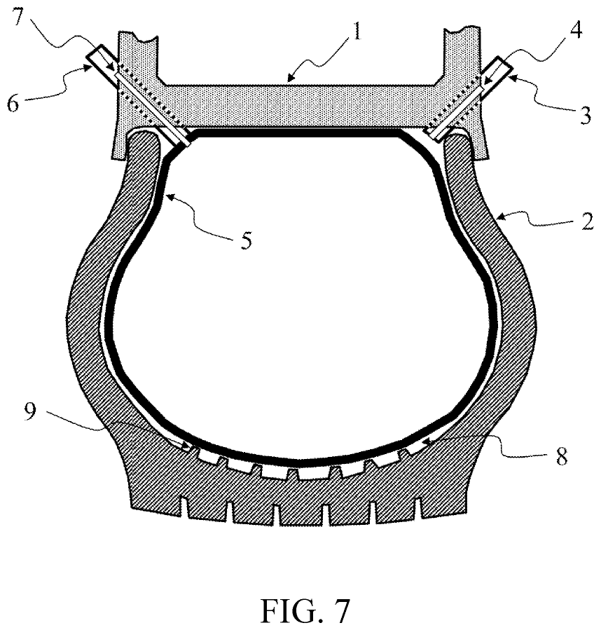

FIG. 2 shows a self-healing tire according to a second embodiment of this disclosure. The self-healing tire of FIG. 2 is similar to the self-healing tire of the first embodiment. Different from the self-healing tire of the first embodiment, the self-healing tire of FIG. 2 further comprises a partition structure 9 disposed between the tire casing 2 and the inner tube 5 for defining and allocating a space between the tire casing 2 and the inner tube 5, which is used as the sealant storing layer 8. The sealant can be stored and flow inside the sealant storing layer 8. Accordingly, the sealant can be controlled to distribute on the desired inner surface of the tire casing 2 that is to be protected or the outer surface of the inner tube 5 that is to be protected, and thus guarantees no excess sealant is required. The partition structure 9 has some protruding portions to separate the inner tube and the tire casing and for controlling the distribution of the sealant inside the self-healing tire. The partition structure 9 can also be designed to divide the sealant layer into numerous sections, so when a leakage on the tire casing occurs the sealant will not be leaked out completely, only the sealant of the respective sections near the leakage is leaked. The partition structure 9 can be attached or integrated on the outer surface of the inner tube 5 (please refer to FIG. 6) or on the inner surface of the tire casing 2 (please refer to FIG. 7), or it can be an independent structure installed, separated from the tire casing 2 and the inner tube 5 (please refer to FIG. 2). The partition structure 9 is pressed by the inflated inner tube 5 against the tire casing 2. Therefore, the shape of the tire casing 2 is held by the high-air-pressure-inflated inner tube 5 along with the partition structure 9.

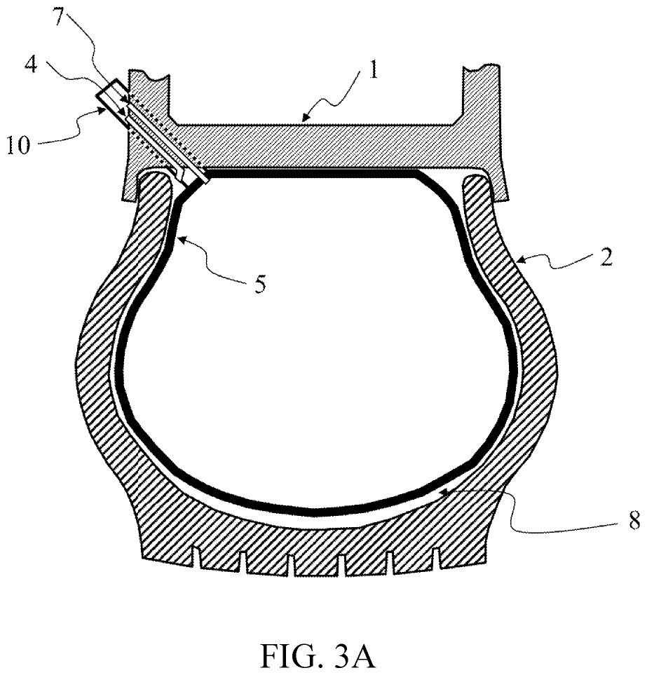

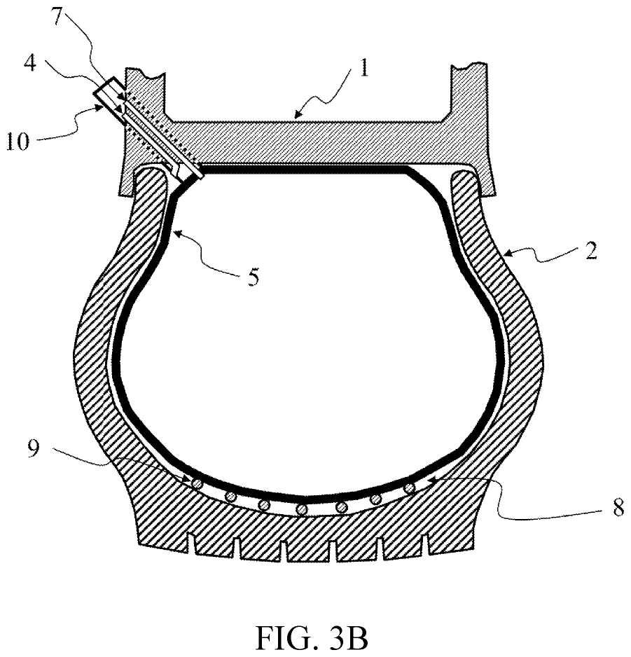

FIG. 3A shows a self-healing tire according to a third embodiment of this disclosure. The self-healing tire of FIG. 3A is similar to the self-healing tire of the first embodiment. Different from the self-healing tire of the first embodiment, in the self-healing tire of FIG. 3A, the first valve stem 3 and the second valve stem 6 are combined into a two-in-one valve stem 10, which protrudes from a nozzle hole of the rim 1. As shown in FIG. 3A, the two-in-one valve stem 10 passes through the hole (nozzle hole) of the rim 1. Therefore, the rim 1 only needs one nozzle hole for installing the two-in-one valve stem 10. The tire casing channel 4 and the inner tube channel 7 are both located inside the two-in-one valve stem 10. Herein, the inner tube channel 7 is connected with the inner space of the inner tube 5, and the tire casing channel 4 is connected with the inner space of the tire casing 2 (e.g. the space between the inner tube 5 and the tire casing 2). This embodiment only needs one valve stem on the rim for inflating the inner tube 5 and injecting the sealant into the sealant storing layer 8 between the tire casing 2 and the inner tube 5. The two-in-one valve stem 10 of this embodiment is suitable for most commercial rims 1, which have only one nozzle hole, and a conventional pneumatic tire without inner tube can be retrofitted into a self-healing tire of this disclosure.

FIG. 3B shows a self-healing tire according to a fourth embodiment of this disclosure. The self-healing tire of FIG. 3B is similar to the self-healing tire of the third embodiment. Different from the self-healing tire of the third embodiment, the self-healing tire of FIG. 3B further comprises a partition structure 9 disposed between the tire casing 2 and the inner tube 5 for defining and allocating a space between the tire casing 2 and the inner tube 5, which is used as the sealant storing layer 8. The sealant can be stored and flow inside the sealant storing layer 8. Accordingly, the sealant can be controlled to distribute on the desired inner surface of the tire casing 2 that is to be protected or desired the outer surface of the inner tube 5 that is to be protected. The partition structure 9 has some protruding portions for controlling the distribution of the sealant inside the self-healing tire. The partition structure 9 can be attached or integrated on the outer surface of the inner tube 5 (please refer to FIG. 6) or on the inner surface of the tire casing 2 (please refer to FIG. 7), or it can be an independent structure installed (please refer to FIG. 3B), separated from the tire casing 2 and the inner tube 5. The partition structure 9 is pressed by the inflated inner tube 5 against the tire casing 2. Therefore, the shape of the tire casing 2 can be held by the air pressure of the inflated inner tube 5 along with the partition structure 9.

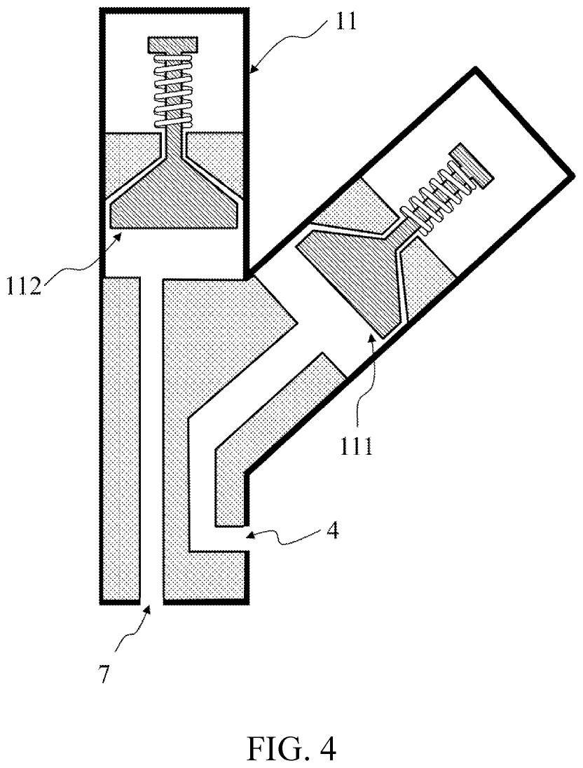

FIG. 4 shows an embodiment of the two-in-one valve stem of the third embodiment and the fourth embodiment. As shown in FIG. 4, the two-in-one valve stem 11 includes two valves (a first valve 111 and a second valve 112) and two channels (a tire casing channel 4 and an inner tube channel 7). The inner tube channel 7 is connected to the inner space of the inner tube 5, and the tire casing channel 4 is connected to the sealant storing layer 8 between the tire casing 2 and the inner tube 5. In this embodiment, the second valve 112 and the inner tube channel 7 are used to inflate the inner tube 5, and the first valve 111 and the tire casing channel 4 are used to inject sealant into the sealant storing layer 8 between the tire casing 2 and the inner tube 5. The two-in-one valve stem 11 of this embodiment is suitable for most commercial rims 1, which have only one nozzle hole, and a conventional pneumatic tire without inner tube can be retrofitted into a self-healing tire of this disclosure.

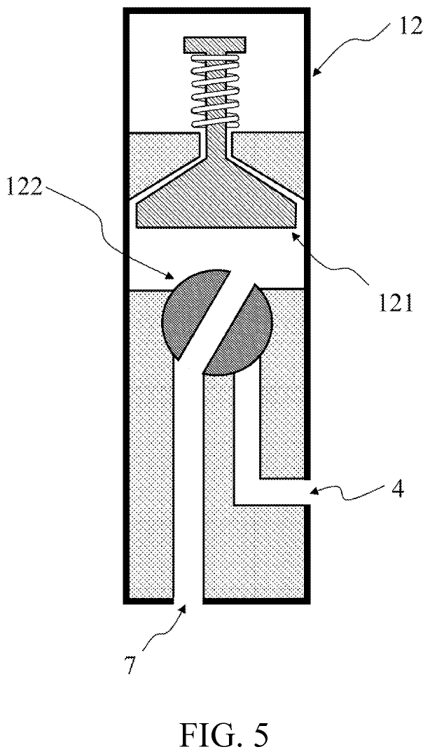

FIG. 5 shows another embodiment of the two-in-one valve stem of the third embodiment and the fourth embodiment. As shown in FIG. 5, the two-in-one valve stem 12 includes a common valve 121, two channels (a tire casing channel 4 and an inner tube channel 7), and a channel selection switch 122, so that the channel of the two-in-one valve stem 12 becomes selectable. The inner tube channel 7 is connected to the inner space of the inner tube 5, and the tire casing channel 4 is connected to the sealant storing layer 8 between the tire casing 2 and the inner tube 5. Accordingly, the channel selection switch 122 can be switched to connect the common valve 121 to either one of the tire casing channel 4 and the inner tube channel 7, thereby selecting the desired operation such as to inflate the inner tube 5 or to inject the sealant into the sealant storing layer 8 between the tire casing 2 and the inner tube 5. The two-in-one valve stem 12 of this embodiment is suitable for most commercial rims 1, which have only one nozzle hole, and a conventional pneumatic tire without inner tube can be retrofitted into a self-healing tire of this disclosure.

FIG. 6 is a schematic diagram showing the partition structure being integrated with the outer surface of the inner tube. FIG. 7 is a schematic diagram showing the partition structure being integrated with the inner surface of the tire casing. The self-healing tires of FIGS. 6-7 are similar to the self-healing tire of the previous embodiment. Different from the self-healing tire of the previous embodiment, in the self-healing tire the partition structure is integrated with the outer surface of the inner tube or integrated with the inner surface of the tire casing. Although FIGS. 6-7 show the valve stems of the self-healing tire are similar to first embodiment of this disclosure, the two-in-one valve stem of the third embodiment and the fourth embodiment also could be apply in the self-healing tire of FIGS. 6-7.

As mentioned above, this disclosure is to add an inner tube inside the pneumatic tire, which originally does not contain any inner tube, and to inject the sealant into the space between the tire casing and the inner tube through the tire casing channel. Thus, the manufacturing cost of the self-healing tire of this disclosure is significantly reduced, the repair of the self-healing tire is much easier, and the self-healing tire of this disclosure can be acquired by retrofitting an existing conventional tire. The partition structure defines the sealant layer and controls the sealant to be at the places where a leakage hole is most likely to occur (for example, the tire tread), therefore the minimum amount of sealant is required for the self-healing tire to work, as the weight of the sealant is at its minimum, the weight of the self-healing tire is reduced, and the self-healing tire will be much easier to steer and most efficient (for driving). Also the liquid sealant will be kept in place and will not fluctuate in the tire when rotating on the road, the stability during rotation is improved. Moreover, the shape of the tire casing is held by the inflated inner tube and the partition structure, not by the sealant. Therefore, the self-healing tire of this disclosure can keep its shape and prevent itself from becoming a flat tire even when all the sealant is being leaked out.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A self-healing tire for vehicles, comprising:
a rim having at least one nozzle hole;
a tire casing installed around the rim;
an inner tube disposed between the rim and the tire casing;
at least one valve stem protruding from the at least one nozzle hole;
a tire casing channel disposed inside the at least one valve stem and connecting to a space between the tire casing and the inner tube;
an inner tube channel disposed inside the at least one valve stem and connecting to an internal space of the inner tube for inflating the inner tube;
a sealant storing layer disposed between the tire casing and the inner tube, wherein the sealant storing layer stores a sealant which is injected through the tire casing channel; and
a partition structure disposed between the tire casing and the inner tube, the partition structure separates the tire casing and the inner tube to form a space to accommodate the sealant so as to form the sealant storing layer;
wherein the at least one valve stem further comprises at least one valve configured to control at least one of the tire casing channel and the inner tube channel;
wherein when the inner tube is inflated, the outer surface of the inflated inner tube contacts the inner surface of the tire casing and the partition structure, and keep the tire casing in shape to withstand the weight of the vehicle.

2. The self-healing tire according to claim 1, wherein the partition structure is integrated with the inner tube and disposed on an outer surface of the inner tube.

3. The self-healing tire according to claim 1, wherein the partition structure is integrated with the tire casing and disposed on an inner surface of the tire casing.

4. The self-healing tire according to claim 1, wherein the at least one valve is a common valve, the valve stem further comprises a channel selection switch, the channel selection switch is configured to selectively control the common valve to be connected with the inner tube channel or the tire casing channel.

5. The self-healing tire according to claim 4, wherein the at least one nozzle hole includes only one nozzle hole, the at least one valve stem includes only one valve stem.

6. The self-healing tire according to claim 1, wherein the at least one valve includes a first valve and a second valve, the first valve is configured to control the tire casing channel, and the second valve is configured to control the inner tube channel.

7. The self-healing tire according to claim 6, wherein the at least one nozzle hole includes only one nozzle hole, and the at least one valve stem includes only one valve stem.

8. The self-healing tire according to claim 1, wherein the at least one nozzle hole includes a first nozzle hole and a second nozzle hole, the at least one valve stem includes a first valve stem and a second valve stem, the first valve stem protrudes from the first nozzle hole, the second valve stem protrudes from the second nozzle hole, the tire casing channel is disposed inside the first valve stem and connecting to the space between the tire casing and the inner tube, the inner tube channel is disposed inside the second valve stem and connecting to the internal space of the inner tube for inflating the inner tube, wherein the first valve stem further comprises a tire casing valve connected with the tire casing channel, and the second valve stem further comprises an inner tube valve connected with the inner tube channel.

9. The self-healing tire according to claim 1, wherein the sealant is a liquid sealant.

10. The self-healing tire according to claim 9, wherein a liquid pressure of the liquid sealant in the sealant storing layer is equal to an air pressure in the inner tube after the inner tube is inflated.

11. The self-healing tire according to claim 10, wherein when the tire casing is punctured, the liquid sealant flows to a punctured hole due to a lower air pressure caused by the punctured-hole-leakage, the outflow liquid sealant contacts the air and seals the punctured hole.
